(19) United States
(12) Patent Application Publication
(10) Pub. No.: US 2011/0101939 A1
(43) Pub. Date: May 5, 2011

(54) DRIVING CONTROLLER, POWER CONVERSION CIRCUIT, AND METHOD FOR MODULATING DRIVING VOLTAGE LEVEL WITH RESPECT TO LOADS

(75) Inventors: CHUNG-MING LENG, Zhongli City (TW); CHANG-HSIN SHEN, Taipei (TW)

(73) Assignee: NIKO SEMICONDUCTOR CO., LTD., Xizhi City (TW)

(21) Appl. No.: 12/785,464

(22) Filed: May 23, 2010

(30) Foreign Application Priority Data
Oct. 30, 2009 (TW) 098136890

(51) Int. Cl. G05F 1/10

(52) U.S. Cl. 323/282

(57) ABSTRACT

A driving controller, power conversion circuit, and method for modulating driving voltage level with respect to a load are disclosed. In which the method, controller and circuit are applied for modulating the driving voltage of a transistor in a power converter. The driving controller includes a load parameter measurement unit, a voltage modulation unit, and a driving control unit. In which the load parameter measurement unit detects a load parameter which represents the magnitude of the load of the power conversion circuit. The voltage modulation unit then modulates the potential level of the driving voltage of the transistors in response to the load parameter for reducing unnecessary power consumption associated with the transistors in the power converter and enhancing overall power efficiency of the power conversion circuit.

### BACKGROUND OF THE INVENTION

1. Field of the Invention

The present invention relates to a driving controller and the method for modulating driving voltage, in particular, to a driving controller and a power conversion circuit for modulating driving voltage level according to load and a method thereof.

2. Description of Related Art

Power Supplies, generally speaking, are usually divided into two categories: linear power supply and switched mode power supply (SMPS). Compared with the linear power supplies, the switched mode ones, which have the advantages of small volume, light weight and high efficiency, contribute to the compact and miniaturization of electronic products, so that they are widespread in various electronic products.

Referring FIG. 1, a typical SR buck DC to DC converter is illustrated. The conventional converter includes a PWM driving unit 10, transistors Q1 and Q2, an inductor L and a capacitor C. The PWM driving unit 10 is used to provide a driving voltage to conduct or cut off the transistors Q1 and Q2. By adjusting the duty cycle of the driving voltage, the period of conduction and cutoff of the transistors Q1 and Q2 could be modulated to convert the higher DC input voltage Vin to a lower DC output voltage Vout, so that the object of converting a voltage source into a lower regulated voltage is offered.

Energy loss must be taken into consideration for circuit designs and electronic applications, no matter which type of the power converter is referred. Generally speaking, the energy loss resulted from the transistors usually includes switching loss and conduction loss. In which the proportion of the switching loss and the conduction loss would be differed by the load of the power converter.

With reference of FIG. 2, the waveforms of current flow and voltage across the transistor from cut-off to conduction for the transistor are illustrated. The waveform 21 represents the voltage across a source and a drain. The waveform 22 represents the current flow through the transistor. In practice, because of the existence of the parasitic capacitance, as the transistor switched from cut-off to conduction, the ideal condition that to have the source-to-drain voltage drop to zero in a sudden and to have the conduction current reach maximum simultaneously could not happen. There will always be a transition period, referred to as the slop parts of waveforms 21 and 22, resulting in the so-called switching loss. The overlapping area by the waveforms 21 and 22 represents the magnitude of the switching loss. The condition is also happened in the period from cut-off to conduction for the transistor.

The current flow of the transistor is small as the power converter is light loaded. The conduction loss is in proportion to conduction resistance Ron and the square of the current flow. Since the current flow of the transistors is small, conduction loss is not the main consideration of power efficiency. On the contrary, the key point would be the value of the switching loss. While the current flow of the transistors is high as the power converter is heavily loaded, the conduction loss is increased for the current flow becomes large. Thus, in contrast with the switching loss, the conduction loss would be the main consideration in circuit design.

FIG. 3A illustrates the relationship of the driving voltage Vgs and the conduction Resistance Ron of the transistor; FIG. 3B illustrates the relationship of the driving voltage Vgs and the gate charge Qg of the transistor. When the transistor is operated under high driving voltage Vgs, the conduction resistance Ron is low yet the gate charge Qg is high. As mentioned, the conduction loss of the transistor is in proportion to the conduction resistance Ron. Thus, when the transistor is applied with high driving voltage, a lower conduction loss would be resulted. However, because of the high gate charge, the transition period (turn-on time or turn-off time) is long and a higher switching loss is thus resulted. Contrarily, a low gate charge Qg is obtained when the transistor is operated under a low driving voltage Vgs, but the conduction resistance Ron would be increased.

Most conventional controllers drives the transistors with a constant driving voltage Vgs. Because the driving voltage level cannot be modulated in response to loads, there would be some unnecessary power waste.

### SUMMARY OF THE INVENTION

In view of the aforementioned issues, the object of the present invention is to modulate the driving voltage of the transistor. The driving voltage from the driving control unit is modified according to the magnitude of the load of the power converter so as to have the transistor operated with high power efficiency. Thus, energy loss resulted from the transistor may decrease and the total power efficiency of the power converter would be improved.

To achieve the above-mentioned objectives, the present invention provides a driving controller applied to a power conversion unit, which includes at least a transistor. The driving controller includes a driving control unit and a voltage modulation unit. The driving control unit couples to the power conversion unit for generating at least a driving signal. The voltage modulation unit couples to the power conversion unit and the driving control unit for converting the driving signal to at least a driving voltage to drive the transistor. The voltage modulation unit obtains a load parameter from the power conversion unit, and modulates the potential level of the driving voltage in response to the load parameter.

The voltage modulation unit may include a voltage amplifier which modulates the potential level of the driving voltage, or a voltage switch unit which switches the potential level of the driving voltage to one of at least two predetermined levels. It is worth mentioning that the voltage modulation unit may further include an amplifying unit for integrating and amplifying the value of the load parameter, so that the voltage amplifier could modulate the potential level of the driving voltage according the amplified parameter.

To achieve the above-mentioned objectives, the present invention further provides a power conversion circuit including a power conversion unit, a driving controller, and a load parameter measurement unit. The driving controller includes a power conversion unit and a voltage modulation unit. The power conversion unit includes at least a transistor, such as a MOSFET, for converting the input power.

The driving control unit couples to the power conversion unit, which could be a PWM controller, for offering at least a driving signal. The load parameter measurement unit couples to the power conversion unit for detecting a load parameter of the power conversion unit. In which an input or output signal of voltage or current flow of the power conversion unit, an induction signal in the power conversion unit, or the signal of voltage or current flow of the transistor could be considered as the load parameter. The voltage modulation unit couples among the power conversion unit, the driving control unit, and the load parameter measurement unit. The voltage modulation unit exerts at least a driving voltage to drive the transistor, and modulates the potential level of the driving voltage in response to the load parameter obtained from the load parameter measurement unit.

To achieve the above-mentioned objectives, the present invention further provides a method for modulating driving voltage level in response to loads. The method is applied for modulating at least a driving voltage for the transistor of a power conversion unit, in which the transistor could be a MOSFET. The method includes steps as follows: measuring a load parameter of the power conversion unit, in which an input or output signal of voltage or current flow of the power conversion unit, an induction signal in the power conversion unit, or the signal of voltage or current flow of the transistor may be considered as the load parameter. Then, a potential level of the driving voltage of the transistor is regulated in response to the load parameter, in which the transistor is driven by the driving voltage.

It is worth mentioning that the modulation of the driving voltage could be accomplished by a voltage amplifier that modulates the potential level of the driving voltage in response to the load parameter, or by a voltage switching unit that switches the potential level of the driving voltage to one of at least two predetermined voltage levels in response to the load parameter.

Therefore, by detecting the magnitude of the load of the power conversion unit and by modulating or switching the potential level of the driving voltage of the transistor in response to the load parameter, the unnecessary power waste can be reduced and the total power efficiency of the power conversion unit can be improved.

For further understanding about the present invention, means and effects which are taken by the present invention for achieving the prescribed objectives, the following detailed descriptions, and appended drawings are hereby referred. Therefore, the purposes, features and aspects of the present invention can be thoroughly and concretely appreciated. However, the appended drawings are merely provided for reference and illustration, without any intention to be used for limiting the scope of the present invention.

### BRIEF DESCRIPTION OF THE DRAWINGS

FIG. 1 is an electrical schematic diagram of a conventional SR Buck DC to DC Converter.

FIG. 2 is a waveform of current flow/voltage of the transistor with switching loss.

FIG. 3A is a relationship curve of the driving voltage Vgs and the conduction Resistance Ron of the transistors.

FIG. 3B is a relationship curve of the driving voltage Vgs and the gate charge Qg of the transistors.

FIG. 4 is a block diagram of a power conversion circuit of a preferred embodiment according to the present invention.

FIG. 5 is a flowchart of a method for modulating driving voltage level of a preferred embodiment in response to loads according to the present invention.

FIG. 6 is an electrical schematic diagram of a power conversion circuit of a preferred embodiment according to the present invention.

FIG. 7 is a waveform of FIG. 6.

FIG. 8 is an electrical schematic diagram of a power conversion circuit in accordance with another preferred embodiment.

FIG. 9 is a waveform of FIG. 8.

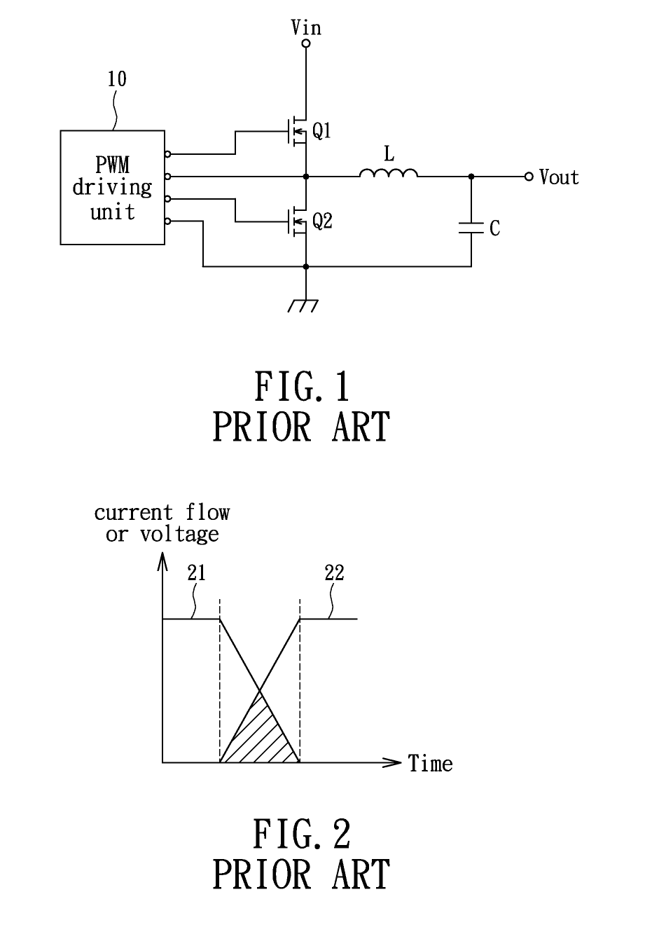

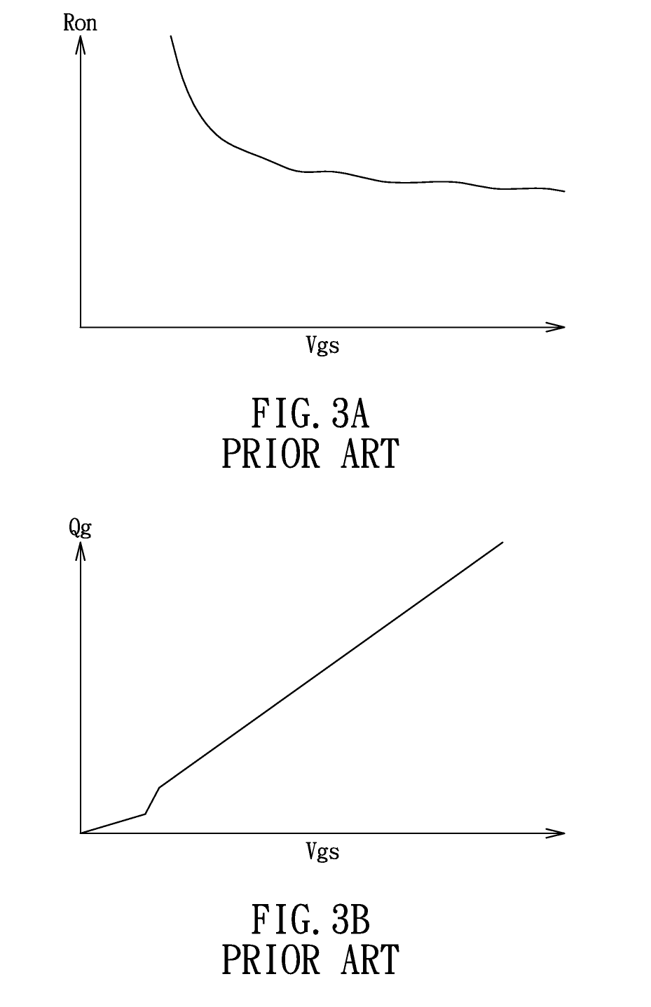

### DETAILED DESCRIPTION OF THE PREFERRED EMBODIMENTS

The present invention is characterized by modulating the potential level of the driving voltage for driving the transistor of the power conversion unit in response to the magnitude of the load, such that the transistor may be operated under low energy loss conditions, and the total power efficiency of the power converter unit may be improved.

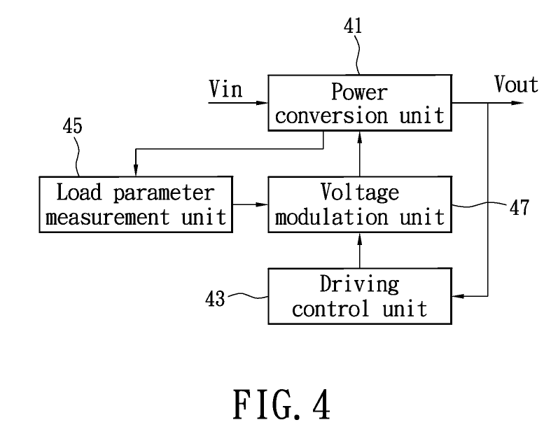

Referring now to FIG. 4, in which a block diagram of a power conversion circuit of a preferred embodiment according to the present invention is disclosed. The power conversion circuit includes a power conversion unit 41, a driving controller and a load parameter measurement unit 45. The driving controller further includes a driving control unit 43 and a voltage modulation unit 47.

The power conversion unit 41 may adapt the circuit of a typical power converter, such as the voltage regulator module (VRM), the DC to DC converter or the AC to DC converter. The topology thereof could be any design, such as a forward converter, a flyback converter or a bridge converter. The power conversion unit 41 receives an input voltage Vin with the forms of direct current (DC) or alternating current (AC), and transforms the input voltage into the output voltage with the forms of DC or AC to meet the required voltage level for the electronic devices at the rear end.

The driving control unit 43 could be a PWM controller to generate a driving signal for controlling the transistor of the power conversion unit 41, which may be a Metal-Oxide-Semiconductor Field Effect Transistor (MOSFET). The driving control unit 43 modifies the duty cycle of the driving signal with respect to the feedback value of the output voltage Vout. Through modifying the duty cycle of the driving signal, the proportion of the conduction and cutoff time could be adjusted for stabilizing the output voltage Vout. Therefore, the output voltage Vout would stay steady without interfered by the variation of input voltage Vin or noises from other circuits.

The load parameter measurement unit 45 is used for detecting the load of the power conversion unit 41. The load parameter measurement unit 45 could be a sensing resistor, which detects the current signal at the input terminal, the output terminal or on a power inductor of the power conversion unit 41, or detects the current signal of the transistor, as a load parameter. The greater the current signal from the power conversion unit 41 is detected, the heavier the load of the power conversion unit 41 is. In addition, the higher the current signal from the transistor is detected, the heavier the load of the power conversion unit 41 is. Therefore, the value of the current signal detected at all the nodes mentioned above could be taken as the load parameter.

As descriptions mentioned above, the change of load parameter detected by the load parameter measurement unit 45 represents the variation of the load. The voltage modulation unit 47 then modulates the potential level of the driving voltage in response to the load parameter. For further details, the voltage modulation unit 47 transforms the driving signal of the driving control unit 43 into a driving voltage. Meanwhile, the voltage modulation unit 47 modulates the potential level of the driving voltage in response to the load parameter. Then the modulated driving voltage is transferred to the power conversion unit 41 in order to control the conduction and cutoff time of the transistor therein.

For further descriptions, because conduction loss is the key consideration as the power converter is operated under heavy load, if a higher value load parameter is detected, which means the load is heavy, a driving voltage with higher voltage level is modulated by the voltage modulation unit 47 to drive the transistor. Thereby, the on resistance Ron of the transistor is decreased to reduce the conduction loss as the transistor operates. In the contrary, if a lower value load parameter is detected, which means the load is light, the switching loss is the key consideration now and a driving voltage with lower voltage level is modulated by the voltage modulation unit 47 to drive the transistor, so that the gate charge Qg decreases to reduce the switching loss of the transistor as the transistor operates.

In other words, the modulated driving voltage and the load parameter would be in positive correlation. The greater the load parameter is, the higher the driving voltage generated by the voltage modulation unit 47 is; the smaller the load parameter is, the lower the driving voltage generated by the voltage modulation unit 47 is.

As to the generation of the driving voltage, a voltage amplifier may be utilized to modulate the driving voltage in response to the value of the load parameter and the driving signal, or to a voltage level switching unit may be utilized to modulate the driving voltage by switching the driving voltage between on of at least two predetermined levels in response to the value of the load parameter.

In addition, the voltage modulation unit 47 may further include an amplifying unit, such as an operational amplifier, for integrating the value of the load parameter from the load parameter measurement unit 45 within a predetermined time period, so as to check the status of the load.

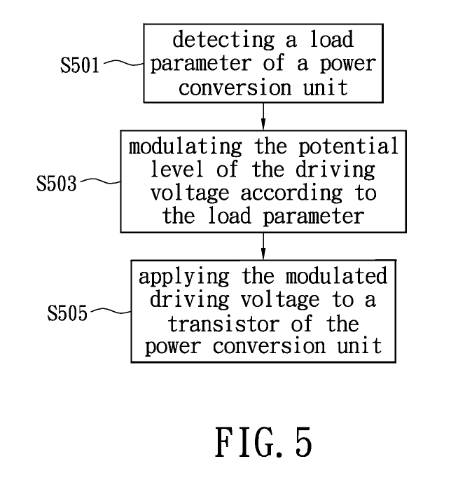

Now referring to FIG. 5, in which a flowchart of a method for modulating driving voltage level in response to a load according to a preferred embodiment the present invention is disclosed. With reference to FIG. 4, the method is applicable to modulate the driving voltage of at least a transistor in a power conversion unit 41. The method for modulating the driving level includes the steps as follows. First, a load parameter of the power converting unit 41 is detected as indicated in step S501. The load parameter may be obtained by detecting one or a combination of the signals, which include an input current signal of the power conversion unit 41, an output current signal of the power conversion unit 41, a current signal of an inductor in the power conversion unit 41, or a current signal of the transistor.

The value of the load parameter represents the magnitude of the load of the power conversion unit 41. The greater the detected load parameter is, the greater the load is. Thereafter, the potential level of the driving voltage is modulated in response to the load parameter as indicated in step S503. In a preferred embodiment, when the power conversion unit 41 is operated under heavy load, the load parameter is greater and the driving voltage of the transistor would be modified to a higher level, when the power conversion unit 41 is in light load, the driving voltage of the transistor would be modified to a lower level, thereby the energy loss of the transistor can be reduced. The levels of the driving voltage of the transistor can be in a linear relationship to the load parameter or switched among at least two fixed levels according to the load parameter.

The above mentioned method for modulating the driving voltage could be achieved by using a voltage amplifier to modify the driving voltage in response to the load parameter or by using a voltage level switching unit to switch the driving voltage between different predetermined voltage levels in response to the load parameter. Lastly, the modulated driving voltage is applied to drive the transistor of the power conversion unit 41 so as to control the conduction and cutoff of the transistor as indicated in step S505.

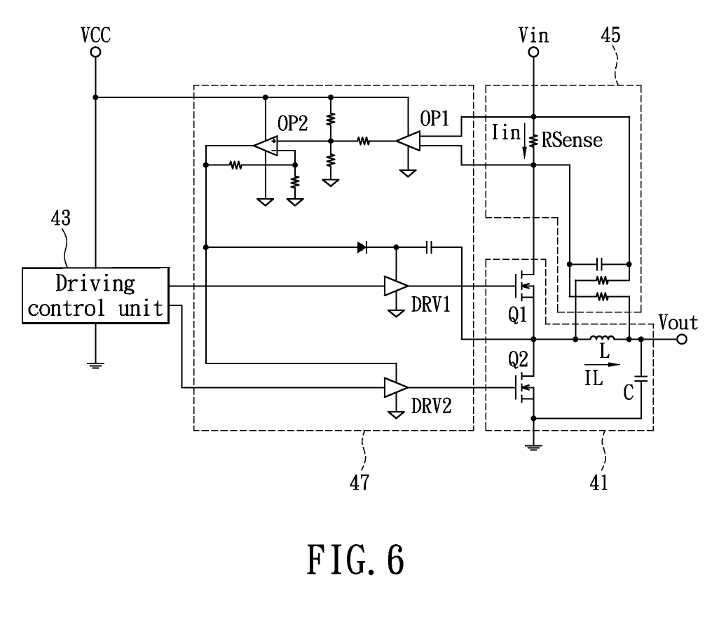

Referring to FIG. 6, in which a circuit diagram of a power conversion circuit of a preferred embodiment according to the present invention is disclosed. The power conversion circuit includes a power conversion unit 41, a driving control unit 43, a load parameter measurement unit 45 and a voltage modulation unit 47. A SR Buck DC to DC Converter is taken as the power conversion unit 41 in this embodiment. The power conversion unit 41 receives the input DC voltage Vin, and controls the proportion of the conduction and the cutoff time of transistors Q1 and Q2 for generating the DC output voltage Vout.

When the transistor Q1 is conducted and the transistor Q2 is cut off, the input voltage Vin charges a power inductor L and a capacitor C and supplies electrical power to the load. When the transistor Q1 is cut off and the transistor Q2 is conducted, the power inductor L and the capacitor C supplies electrical power to the load instead. In which the duty cycles of the transistors Q1 and Q2 are modulated by the driving control unit 43 for modifying the proportion of the conduction and cutoff time of the transistors Q1 and Q2, so that the potential level of the output voltage Vout can be modified to achieve DC to DC converting result.

With reference to FIG. 6, the load parameter measurement unit 45 may be arranged at an input terminal of the power conversion unit 41, such as the resistor RSense, to detect the input current Iin, or the load parameter measurement unit 45 may be connected in parallel to the power inductor L of the power conversion unit 41 to detect the current IL on the power inductor L. In this embodiment, the load parameter measurement unit 45 detects both the input current Iin and the inductor current IL as the load parameters, which represent the variation of load. The load parameter measurement unit 45 further transforms the currents Iin and IL into a voltage difference V and transmits the voltage difference V to the voltage modulation unit 47.

The voltage modulation unit 47 includes at least an amplifying unit, such as the operation amplifiers OP1 and OP2, to integrate the value of the load parameter. The voltage modulation unit 47 includes two voltage amplifiers DRV1 and DRV2, which receive the driving signals from the driving control unit 43 to generate driving voltages for driving the transistors Q1 and Q2 and modulate the potential level of the driving voltage according to the load parameters of the load parameter measurement unit 45. When the load parameter is getting greater, the modulated driving voltages, which are modulated by the two voltage amplifiers DRV1 and DRV2, are getting higher. In contrast, when the load parameter is getting smaller, the modulated driving voltages are getting lower.

Specifically, the potential level of the driving voltages from the two voltage amplifiers DRV1 and DRV2 could be the same or different. In addition, only one of driving voltages for driving the transistors Q1 and Q2 being selected for modulation is also allowable in accordance with the present invention. For example, if the transistor Q1 requires a driving voltage higher than that requested by the transistor Q2, the driving voltage of the transistor Q1 would be kept at a high level, and only the driving voltage of transistor Q2 is modulated between a low level and the aforementioned high level in response to the load parameter. The low level may be set as a driving voltage level for the power conversion unit 41 operated in a normal load mode.

It is worth mentioning that except modulating the potential level of the driving voltage by using the voltage amplifying unit, the voltage modulation unit 47 may use a voltage switching unit to switch the driving voltage to be a predetermined level according to the load parameters. For example, the voltage switching unit could selectively modulate the voltage provided to the voltage amplifiers DRV1 and DRV2 to a high or a low level according to the variation of load parameter, so that two modulated driving voltage of different levels are formed. When the load parameter is greater than a predetermined value, the voltage switching unit will choose the high level voltage applying to the voltage amplifiers DRV1 and DRV2. On the contrary, when the load parameter is smaller than the predetermined value, the low level one may be selected. Therefore, under heavy load, the high level driving voltage is generated to decrease the resistance Ron of the transistor so as to reduce the conducting loss. Under light load, the low level driving voltage is generated to decrease the gate charge Qg of the transistor so as to reduce the switching loss. The unwanted power waste due to conducting loss and switching loss is thus reduced.

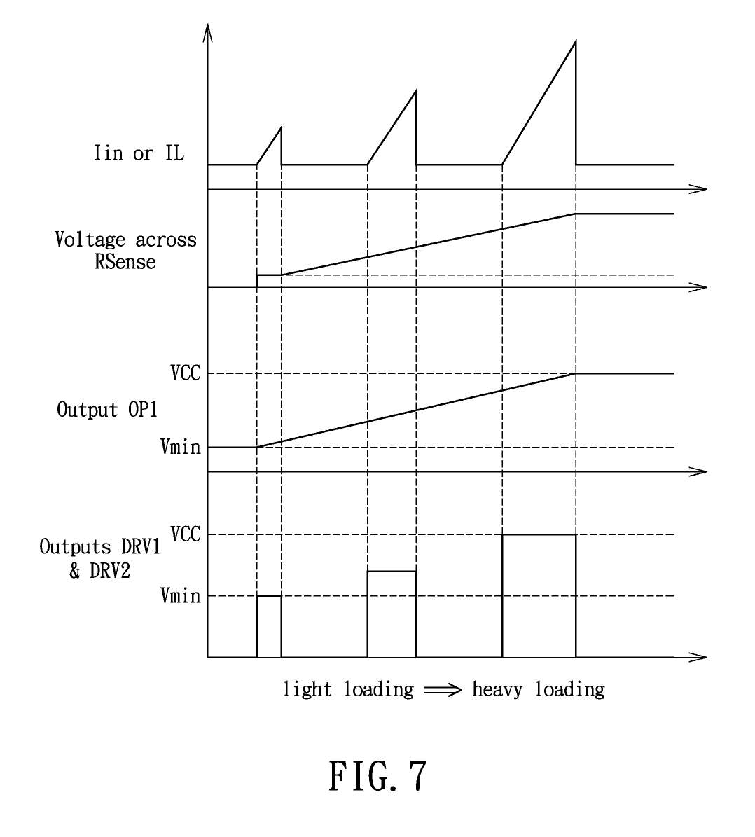

Referring to FIG. 7, in which a diagram showing the waveforms of the signals in FIG. 6 with respect to the load is disclosed. As the load is increased, the load parameter, such as the input current Iin or the induction current IL, increases. The value of the load parameter is integrated by the operation amplifiers OP1 and OP2 so as to have the driving amplifiers DRV1 and DRV2 modulate the voltage level of the driving voltages in correspondence to the load parameter. The voltage Vmin shown in FIG. 7 represents the minimum voltages capable for driving the transistor Q1 and Q2, which is the lowest driving voltage able to turn on the transistors Q1 and Q2.

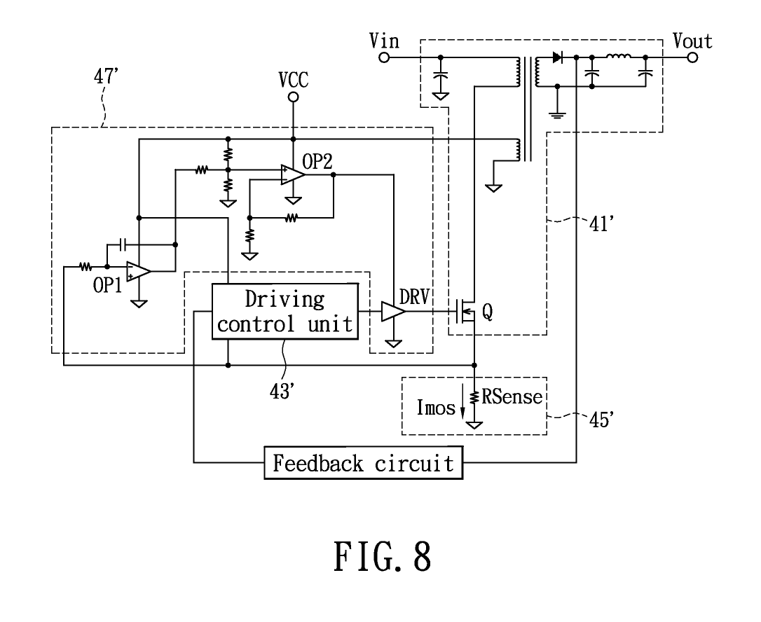

Referring to FIG. 8, in which a circuit diagram of a power conversion circuit according to another preferred embodiment is disclosed. The power conversion circuit includes a power conversion unit 41′, a driving control unit 43′, a load parameter measurement unit 45′ and a voltage modulation unit 47′. The power conversion unit 41′ is a typical flyback power converter. The details of the operation of the well known flyback power converter are skipped here.

The load parameter measurement unit 45′, shown as resistor RSense in FIG. 8, is set at a source terminal of a transistor Q in the power conversion unit 41′ to detect the current flow Imos flowing through the transistor Q thereof and to generate a load parameter transmitted to the voltage modulation unit 47′. The source terminal of the transistor Q is grounded in the present embodiment. It is worth mentioning that the greater the signal at the input end of the power conversion unit 41′, such as the input current Iin in FIG. 6, the signal at the output end of the power conversion unit 41′, the current signal on the inductor, such as the induction current IL in FIG. 6, or the detected signal of the transistor, such as the current flow Imos of the transistor in FIG. 8, the heavier the load is. Thus, as long as the detect nodes are set properly, the detected values could be taken as the load parameters.

The voltage modulation unit 47′ could include at least an amplifying unit, such as operation amplifiers OP1 and OP2 shown in figure. The amplifying unit integrates the load parameter to check the load status. The voltage modulation unit 47′ further includes a voltage amplifier DRV, which transforms the driving signal of the driving control unit 43′ into driving voltage with different voltage levels in response to the load parameter transmitted from the load parameter measurement unit 45′. In the embodiment, the load parameter represents the magnitude of the load. The greater the load parameter is, the higher the modulated driving voltage level is; the smaller the load parameter is, the lower the modulated driving voltage level is. Thus, the unnecessary power waste due to the transistor Q is decreased.

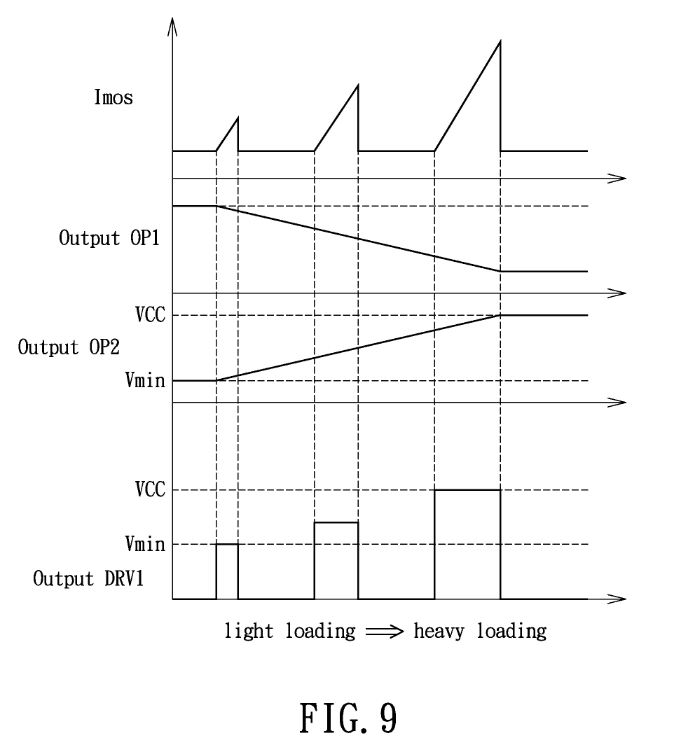

Referring to FIG. 9, in which the waveforms of the signals in FIG. 8 with respect to the load are disclosed. The heavier the load is, the greater the current flow Imos is, as illustrated in drawing. The value of the load parameter, the current flow Imos, is integrated by the operation amplifiers OP 1 and OP2. The driving voltage output by the voltage amplifier DRV is modulated in response to the integrated value of the load parameter. The voltage Vmin shown in FIG. 9 represents the minimum voltages for driving the transistor Q, which is the lowest voltage level capable to turn on the transistor Q.

In summary, the power conversion circuit provided in the present invention may modulate the driving voltage of the transistor within the power conversion circuit according to the detected load of the power conversion circuit so as to decrease the energy loss and the total power efficiency of the power conversion circuit is thus improved.

The above-mentioned descriptions represent some of the embodiments of the present invention, without any intention to limit the scope of the present invention thereto. Various equivalent changes, alternations or modifications based on the claims of present invention are all consequently viewed as being embraced by the scope of the present invention.

What is claimed is:

1. A method for modulating driving voltage level with respect to loads, applied in modulating at least a driving voltage of at least a transistor of a power conversion unit, comprising:
measuring a load parameter; and
modulating a potential level of the driving voltage of the transistor in response to the load parameter.

2. The method according to claim 1, wherein the step of measuring the load parameter comprises detecting at least one or a combination of signals including an input signal, an output signal, and an induction signal of the power conversion unit, and at least one signal respective to the transistor as the load parameter.

3. The method according to claim 1, wherein the step of modulating the potential level of the driving voltage of the transistor in response to the load parameter is performed by modulating the potential level of the driving voltage via a voltage amplifier.

4. The method according to claim 1, wherein the step of modulating the potential level of the driving voltage of the transistor in response to the load parameter is performed by switching the potential level of the driving voltage between a high level and a low level via a voltage switching unit.

5. The method according to claim 1, wherein the potential level of the driving voltage is modulated between a high level and a low level in response to the load parameter, and the low level is a lowest voltage for driving the transistor.

6. A driving controller, applied to a power conversion unit including at least a transistor; comprising:
a driving control unit, coupled to the power conversion unit, and generating at least a driving signal; and
a voltage modulation unit, coupled to the power conversion unit and the driving control unit for converting the driving signal to at least a driving voltage to drive the transistor, obtaining a load parameter from the power conversion unit, and modulating the potential level of the driving voltage in response to the load parameter.

7. The driving controller according to claim 6, wherein the driving control unit is a pulse-width modulation (PWM) controller.

8. The driving controller according to claim 6, wherein the voltage modulation unit includes a voltage switch unit, which switches the potential level of the driving voltage to one of at least two predetermined levels in response to the load parameter.

9. The driving controller according to claim 6, wherein the voltage modulation unit includes an amplifying unit, which integrates the value of the load parameter over a predetermined time.

10. The driving controller according to claim 9, wherein the voltage modulation unit includes a voltage amplifier, which modulates the potential level of the driving voltage in response to a signal from the amplifying unit.

11. The driving controller according to claim 6, further including:
a load parameter measurement unit, coupled to the power conversion unit and the voltage modulation unit, detecting the load parameter from the power conversion unit and transferring the load parameter to the voltage modulation unit;
wherein the load parameter measurement unit detects at least one or a combination of signals including an input signal, an output signal, and an induction signal of the power conversion unit, and at least one signal respective to the transistor as the load parameter.

12. The driving controller according to claim 11, wherein the load parameter measurement unit is a sensing resistor.

13. A power conversion circuit comprising:
a power conversion unit with at least a transistor;
a driving control unit, coupled to the power conversion unit, and generating at least a driving signal;
a load parameter measurement unit, coupled to the power conversion unit, for detecting a load parameter of the power conversion unit;
a voltage modulation unit, coupled to the power conversion unit, the driving control unit and the load parameter measurement unit, for generating at least a driving voltage to drive the transistor, receiving the load parameter from the load parameter measurement unit, and modulating the potential level of the driving voltage in response to the load parameter.

14. The power conversion circuit according to claim 13, wherein the driving control unit is a pulse-width modulation (PWM) controller.

15. The power conversion circuit according to claim 13, wherein the load parameter measurement unit is a sensing resistor.

16. The power conversion circuit according to claim 13, wherein the load parameter measurement unit detects at least one or a combination of signals including an input signal, an output signal, and an induction signal of the power conversion unit, and at least one signal respective to the transistor as the load parameter.

17. The power conversion circuit according to claim 13, wherein the voltage modulation unit includes an amplifying unit, which integrates the value of the load parameter over a predetermined time.

18. The power conversion circuit according to claim 13, wherein the voltage modulation unit includes a voltage amplifier, which modulates the potential level of the driving voltage in response to the load parameter.

19. The power conversion circuit according to claim 13, wherein the voltage modulation unit includes a voltage switching unit, which switches the potential level of the driving voltage to one of at least two predetermined levels in response to the load parameter.

20. The power conversion circuit according to claim 17, wherein the voltage modulation unit includes a voltage amplifier, which modulates the potential level of the driving voltage in response to a signal outputted from the amplifying unit.
